(19) United States
(12) Patent Application Publication
(10) Pub. No.: US 2024/0283168 A1
(43) Pub. Date: Aug. 22, 2024

(54) ULTRA-WIDE BAND SINGLE-ENDED ADDITIVELY MANUFACTURED MODULAR APERTURE ANTENNA

(71) Applicant: BAE SYSTEMS Information and Electronic Systems Integration Inc., Nashua, NH (US)

(72) Inventors: Jacob Tamasy, Nashua, NH (US); Alexander D. Johnson, Waltham, MA (US); James F. Fung, Manchester, NH (US)

(73) Assignee: BAE SYSTEMS Information and Electronic Systems Integration Inc., Nashua, NH (US)

(21) Appl. No.: 18/170,859

(22) Filed: Feb. 17, 2023

(51) Int. Cl. H01Q 21/24; B33Y 10/00; B33Y 80/00; H01Q 1/48; H01Q 5/25; H01Q 9/16

(52) U.S. Cl. CPC H01Q 21/24; B33Y 10/00; B33Y 80/00; H01Q 1/48; H01Q 5/25; H01Q 9/16

(57) ABSTRACT

An antenna assembly includes at least one conductive dipole arm and an adjacent conductive wall (“H-wall”), which enables efficient radiation from the conductive dipole arm without added losses. A single-ended antenna feed is configured to receive a single-ended signal. The antenna assembly further includes a ground plane and a conductive dipole arm in planar alignment with a surface of the ground plane. The conductive wall is electrically coupled with the ground plane and has an end adjacent to, and physically separate from, the conductive dipole arm, an axial length of the H-wall being orthogonal to the ground plane. The antenna assembly further includes a feedline electrically coupled with the conductive dipole arm and the single-ended antenna feed.

### FIELD OF DISCLOSURE

The present disclosure relates to antennas, and more particularly, to bandwidth extended additively manufactured modular aperture antennas and antenna arrays.

### BACKGROUND

An antenna transduces electromagnetic (EM) waves to radio frequency (RF) electrical signals. An aperture is typically considered as the portion of a surface of an antenna through which a majority of the EM waves are transmitted or received. Antennas can be arranged in arrays to provide wideband and ultra-wideband (UWB) operations, such as in conjunction with radar and tracking systems, high data rate communication links, and multi-waveform, multi-function front end systems.

### BRIEF DESCRIPTION OF THE DRAWINGS

FIG. 1 is a schematic diagram of a tightly coupled dipole array (“TCDA”), in accordance with an example of the present disclosure.

FIG. 2 is another schematic diagram of the TCDA of FIG. 1, in accordance with an example of the present disclosure.

FIGS. 3A-D are top isometric perspective and plan views of a modular antenna, according to an example of the present disclosure.

FIGS. 4A-F are top isometric perspective views of various structures during several stages of fabrication of the modular antenna of FIGS. 3A-D, in accordance with an example of the present disclosure.

FIG. 4G is a cross-sectional plan view of the modular antenna of FIGS. 3A-D, in accordance with an example of the present disclosure.

FIG. 5 is a top isometric perspective view of a modular antenna, according to another example of the present disclosure.

Although the following detailed description will proceed with reference being made to illustrative examples, many alternatives, modifications, and variations thereof will be apparent in light of this disclosure.

### DETAILED DESCRIPTION

In accordance with an example of the present disclosure, an antenna assembly with single linear polarization includes at least one conductive dipole arm and an adjacent conductive wall (“H-wall”), which enables efficient radiation from the conductive dipole arm without added losses. A single-ended antenna feed is configured to receive a single-ended signal. The antenna assembly further includes a ground plane and a conductive dipole arm in planar alignment with a surface of the ground plane. The conductive wall is electrically coupled with the ground plane and has an end adjacent to, and physically separate from, the conductive dipole arm, an axial length of the H-wall being orthogonal to the ground plane. The H-wall is physically connected to the ground plane and electrically couples the ground plane to the dipole arm. The antenna assembly further includes a feedline electrically coupled with the conductive dipole arm and the single-ended antenna feed.

In accordance with an example of the present disclosure, an antenna assembly with dual polarization includes a single-ended antenna feed configured to receive or transmit a single-ended signal, a ground plane, a first conductive dipole arm in planar alignment with a surface of the ground plane, and a second conductive dipole arm in planar alignment with the surface of the ground plane and adjacent to the first conductive dipole arm. The antenna assembly further includes a first feedline electrically coupled with the first conductive dipole arm and the single-ended antenna feed, and a second feedline electrically coupled with the second conductive dipole arm and the ground plane. The antenna assembly further includes a conductive wall (“H-wall”) electrically coupled with the ground plane and having an end adjacent to, and physically separate from, the first conductive dipole arm, an axial length of the H-wall being orthogonal to the ground plane. The H-wall is physically connected to the ground plane and electrically couples the ground plane to the first and second dipole arms.

In some examples, the assembly includes an integral element additively manufactured into a single continuous piece of material. For example, the integral element includes the ground plane, the first conductive dipole arm, the second conductive dipole arm, the first feedline, the second feedline, and the H-wall. The integral element includes an electrically conductive material, or a non-conductive material plated with an electrically conductive material. In some examples, the assembly further includes a non-conductive structural support, such as a controlled dielectric foam or resin, surrounding integral element and incorporated into the electrical design of the assembly. The non-conductive structural support provides mechanical stability for the integral element and can also include sacrificial features that can be removed during fabrication of the assembly. For example, the assembly can be manufactured using any suitable additive or subtractive manufacturing process, including, but not limited to, 3-D printing, casting, computer numerical control (CNC), or the like. In some examples, the assembly can be manufactured as a single continuous unit or structure. In some other examples, individual components of the assembly can be manufactured separately and assembled. According to another example, the assembly can include any suitable material encased in, coated with, or otherwise covered with a conductive material, such as a conductive metal or the like to provide a conductive metal surface. For example, the assembly can include a plastic core with a conductive surface coating thereon.

### Overview

Dipole apertures can be arrayed to provide wideband and ultra-wideband applications. The bandwidth ratio is expressed as a function of the upper frequency band of the antenna divided by the lower frequency band of the antenna. Ultra-wideband operation is typically considered to include antenna arrays having a bandwidth ratio of 6:1 or greater, also referred to herein as a technology for transmitting information across a wide bandwidth′. An example of such an antenna array includes a tightly coupled dipole array (TCDA), the aperture of which includes a cluster of closely spaced dipole elements extending from a ground plane. For instance, TCDA is an aperture type commonly used in a digital phased array (DPA) that provides UWB operation and a large field of view (FOV).

### Example TCDA

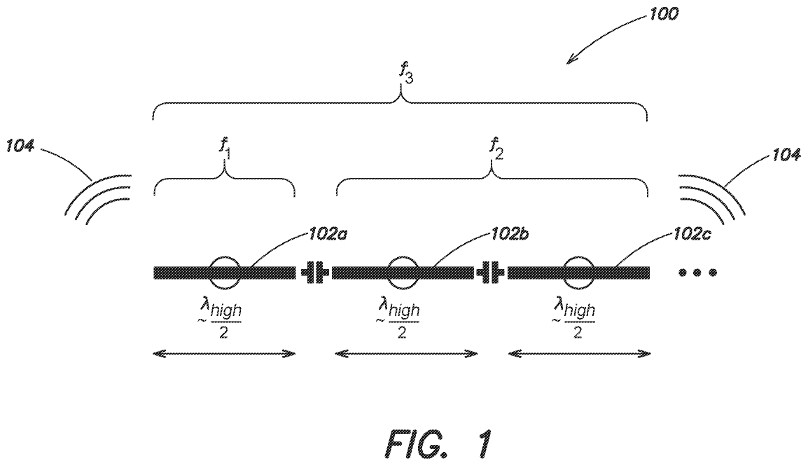

FIG. 1 is a schematic diagram of a TCDA 100, in accordance with an example of the present disclosure. The TCDA 100 includes multiple half wave dipole antennas 102a, 102b, 102c, etc. Each dipole antenna 102a, 102b, 102c, can radiate or receive a signal 104 at a frequency of approximately

$$\frac{{λ}_{1}}{2} , \frac{{λ}_{2}}{2} , and \frac{{λ}_{3}}{2} ,$$

respectively. An individual dipole antenna, such as dipole antenna 102a, radiates or receives a signal at a frequency f₁. The dipole antennas 102a, 102b, 102c can be located or arrayed adjacent to each other to radiate or receive signals at frequencies f₂, f₃, etc., such as shown in FIG. 1. Such an arrangement approximates a near-linear current distribution across all of the dipole antennas 102a, 102b, 102c.

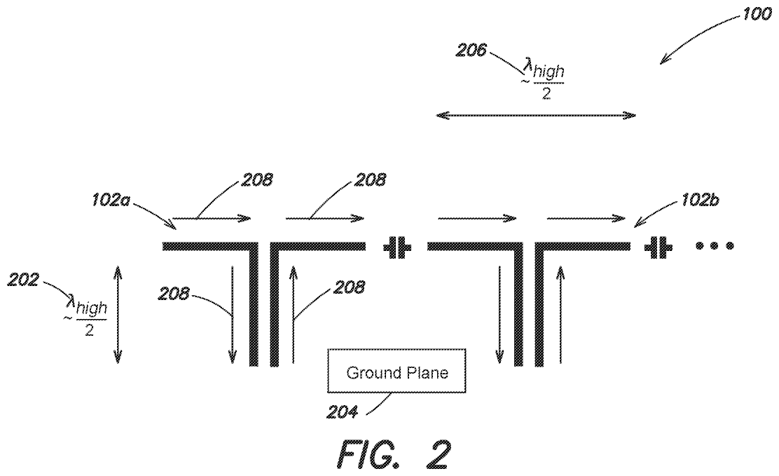

FIG. 2 is another schematic diagram of the TCDA 100 of FIG. 1, in accordance with an example of the present disclosure. The upper cutoff frequency of the TCDA 100 is established by an array pitch (element width) 206 of each of the antennas 102a, 102b and is affected by the height 202 of the dipole elements above a ground plane 204. The lower cutoff frequency can be extended by coupling each of the antennas 102a, 102b (and any other antennas) or through the presence of dielectric loading in the substrate and is affected by the height 202 of the dipole elements above a ground plane 204.

TCDAs can be fed by balanced or unbalanced feed structures. Some existing TCDAs have wideband, single-ended (unbalanced) feeds while others have differential (balanced) feeds. For example, in a single-ended dipole arrangement, one dipole arm is energized by the signal while the other dipole arm is shorted to a ground potential. By contrast, a balanced feed antenna has complementary signals 208 in the adjacent conductive elements, such as shown in FIG. 2.

TCDA of both feeding types can suffer from common mode resonances, which affect antenna performance. For example, a signal radiating from one or more of the dipole antennas 102a, 102b can excite a common mode resonance upon a balanced feed of the adjacent dipole antenna(s) 102a, 102b when scanning in the ground plane 204 over a wide or ultra-wideband frequency range. The common mode resonance radiating from the antenna can interfere with and alter the phase of the signal on the feed line (also referred to as signal coupling), creating an unbalanced current that degrades the signal strength and reduces antenna efficiency. Thus, there are various methods to eliminate common mode resonances, including H-walls and shorting posts.

TCDA design is a multi-faceted balancing act of parameters that require deep understanding of electromagnetic phenomenon. Wide bandwidth TCDAs enable the antenna to perform several functions (e.g., transmit and receive several signals across a wide range of frequencies, e.g., >500 MHz) at a single aperture. To achieve these functions efficiently, the antenna are often designed to reduce or eliminate losses, for example, resistive losses and mismatch losses. Mismatch losses are reduced by physically tuning the aperture to the system impedance or using superstrates or the like. Resistive losses can improve mismatch but come with an efficiency degradation. However, lossless TCDA are limited in bandwidth by physical constraints, requiring lossy loading to be employed in some scenarios.

Thus, there is a need for a TCDA antenna that is easily scalable and can trade an ultra-wide bandwidth versus incurred losses.

### Example Modular Antenna Array

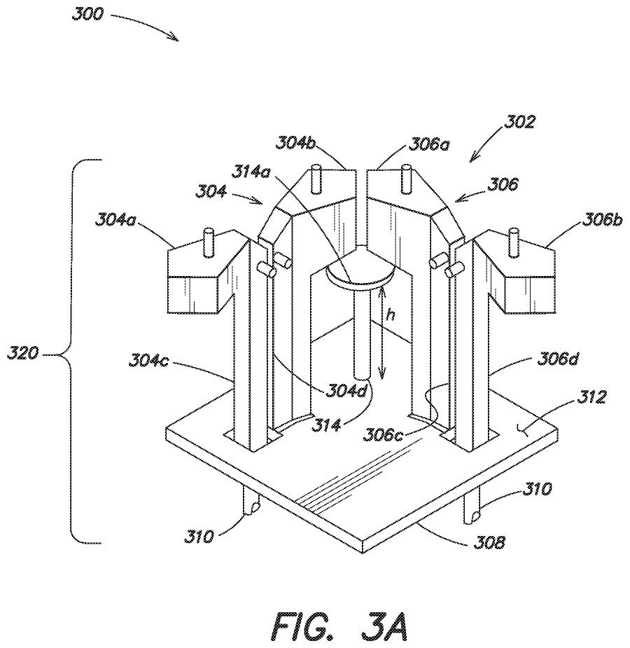

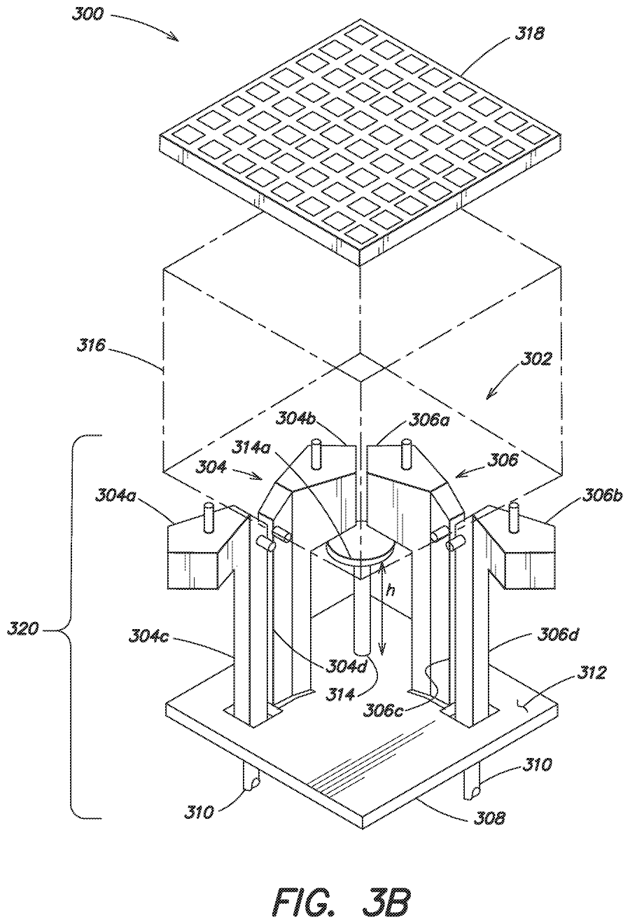

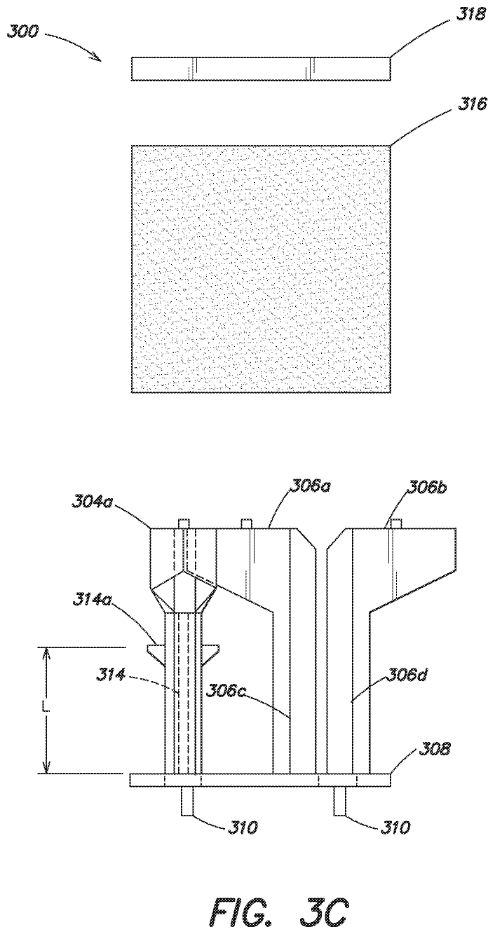

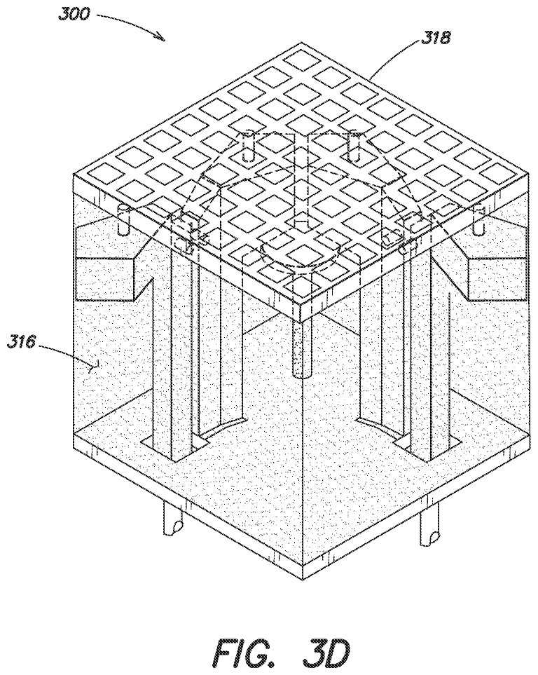

FIGS. 3A-D are top isometric perspective and plan views of a modular antenna 300, according to an example of the present disclosure. The antenna 300 includes a 1×1 unit cell 302. The antenna 300 can, in some examples, include multiple unit cells arrayed together, such as 3×3, 6×6, etc., where each unit cell is similar to the 1×1 unit cell 302 shown in FIG. 3A. In any event, the antenna 300 includes one or more 1×1 unit cells 302.

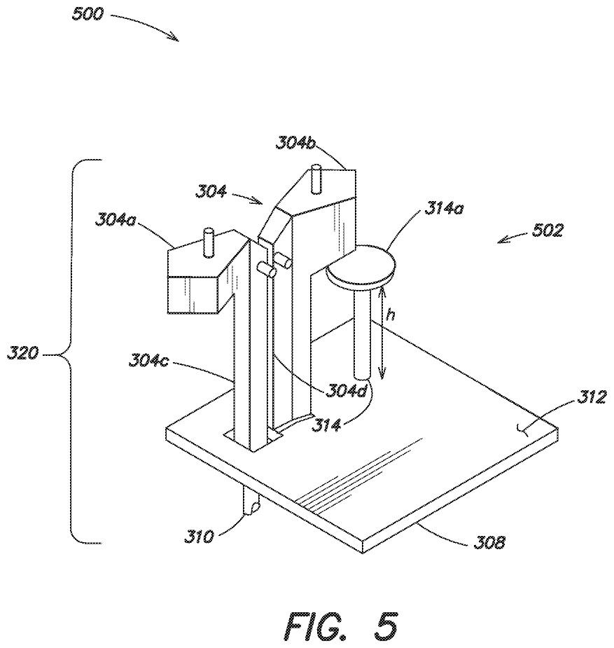

Referring to FIG. 3A, the unit cell 302 includes a first antenna element 304, a second antenna element 306, a ground plane 308, and at least one single-ended antenna feed 310. It will be understood that in some examples, it is not necessary to include both the first and second antenna elements 304, 306. For example, FIG. 5 shows a modular antenna 500 with a unit cell 502 including a single antenna element 304 (with corresponding elements as described herein) for single linear polarization, in accordance with an example of the present disclosure. In some other examples, such as shown and described with respect to FIG. 3A, the unit cell 302 includes both the first and second antenna elements 304, 306 (e.g., two orthogonal arrays) for dual polarization. The single-ended antenna feed 310 is configured to receive a single-ended (unbalanced) signal. Each antenna element 304, 306 includes a first conductive dipole arm 304a, 306a and a second conductive dipole arm 304b, 306b. The first conductive dipole arm 304a, 306a and the second conductive dipole arm 304b, 306b are each in planar alignment with a surface 312 of the ground plane 308. In some examples, the first conductive dipole arm 304a, 306a is a mirror image of the second conductive dipole arm 304b, 306b about a longitudinal axis extending perpendicular to the surface 312 of the ground plane 308, such that the first conductive dipole arm 304a, 306a is adjacent to the second conductive dipole arm 304b, 306b. Each antenna element 304, 306 further includes a first feedline 304c, 306c electrically coupled with the first conductive dipole arm 304a, 306a and the single-ended antenna feed 310, and a second feedline 304d, 306d electrically coupled with the second conductive dipole arm 304b, 306b and the ground plane 308.

The unit cell 302 further includes a conductive wall (“H-wall”) 314 electrically coupled with the ground plane 308. The H-wall 314 has an end 314a adjacent to, and physically separate from, the second conductive dipole arm 304b of the first antenna element 304 and the first conductive dipole arm 306a of the second antenna element 306. An axial length/of the H-wall 314 is orthogonal to the ground plane 308. In other words, the H-wall 314 extends orthogonally from the ground plane 308 toward the second conductive dipole arm 304b of the first antenna element 304 and the first conductive dipole arm 306a of the second antenna element 306. The H-wall 314 does not physically contact the first or second antenna elements 304, 306. Rather, the H-wall 314 disrupts the common mode resonances (e.g., the coupled signal between adjacent unit cells 302) that would otherwise cause feed line radiation/coupling and reduce antenna efficiency. The H-wall 314 electrically couples the ground plane to the dipole arm(s). As a result, the H-wall 314 enables efficient radiation from the first and second conductive dipole arms 304a, 304b, 306a, 306b without added losses such that a bandwidth ratio of the antenna aperture can reach or exceed 10:1 (e.g., between approximately 2-20 GHz) or greater for single-ended operation while using a single-ended feed and without a balun or other components for mitigating the common mode resonances.

Referring to FIGS. 3B-C, which are exploded views of the modular antenna 300 of FIG. 3D, in some examples the unit cell 302 further includes at least one non-conductive structural support element 316 between the ground plane 308 and the first feedline 304c, 306c, the second feedline 304d, 306d, or both feedlines 304c, 306c, 304d, 306d of the first and second antenna elements 304, 306, respectively. In some examples, the at least one non-conductive structural support element 316 includes a controlled dielectric foam or resin surrounding the antenna elements 304 and 306. The at least one non-conductive structural support element 316 provides mechanical stability and an alignment feature for the first antenna element 304 and/or the second antenna element 306 and can also include sacrificial features that can be removed during fabrication of the unit cell 302, such as during an additive manufacturing process where components of the unit cell 302 (e.g., the ground plane 308, the feedlines 304c, 304d, 306c, 306d, and the dipole arms 304a, 304b, 306a, 306b) are fabricated by the successive addition of material (e.g., via a three-dimensional printing or other material deposition process). In some examples, the at least one non-conductive structural support element 316 is incorporated into the electrical design of the modular antenna 300.

In some examples, the first conductive dipole arms 304a, 306a are linearly polarized with respect to a first plane of polarization (e.g., V-pol), and the second conductive dipole arms 304b, 306b are linearly polarized with respect to a second plane of polarization (e.g., H-pol), where the first plane of polarization is orthogonal to the second plane of polarization.

In operation, a signal, such as an analog RF signal, can propagate to the first conductive dipole arms 304a, 306a from the single-ended antenna feed 310 via the first feedline 304c, 306c. The second conductive dipole arms 304b, 306b are grounded to the ground plane 308.

As seen in FIG. 3B, in some examples, the unit cell 302, or an array of unit cells 302, is covered by a superstrate 318 or another overlay material. The superstrate 318 can include dielectric or other impedance matching materials to improve the match of the modular antenna 300 to increase bandwidth and reduce mismatch loss.

### Modular Antenna Array Fabrication

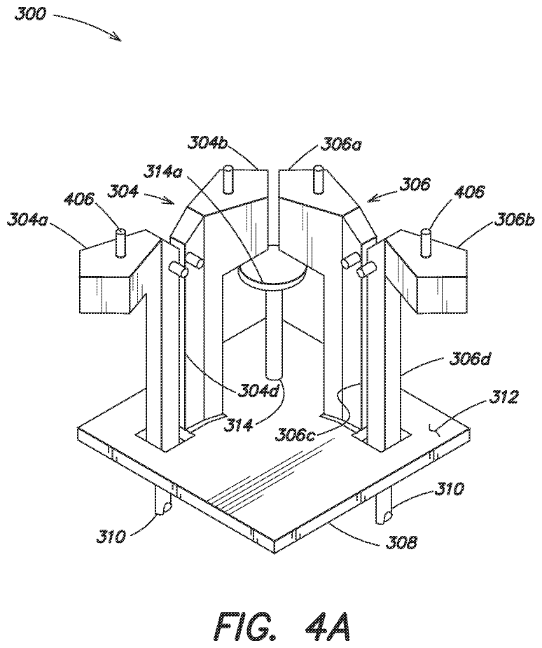

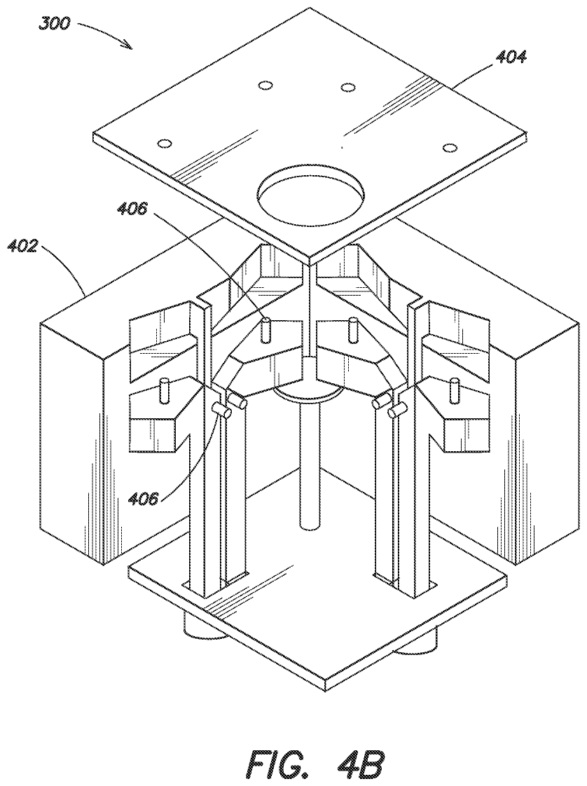

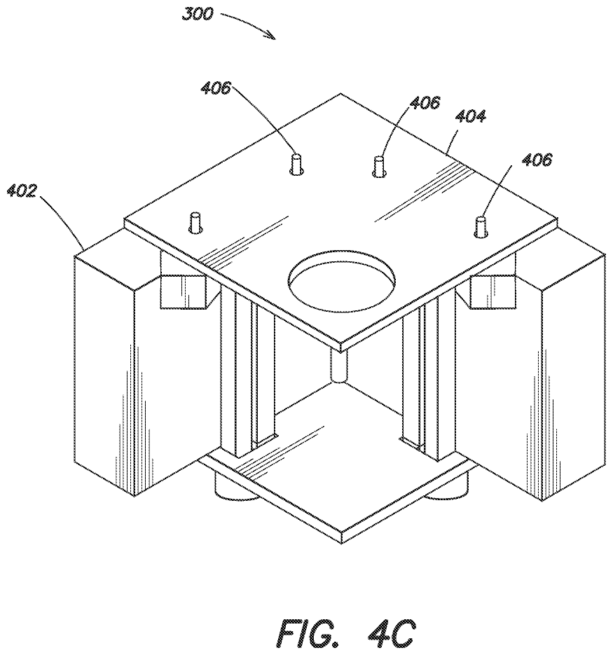

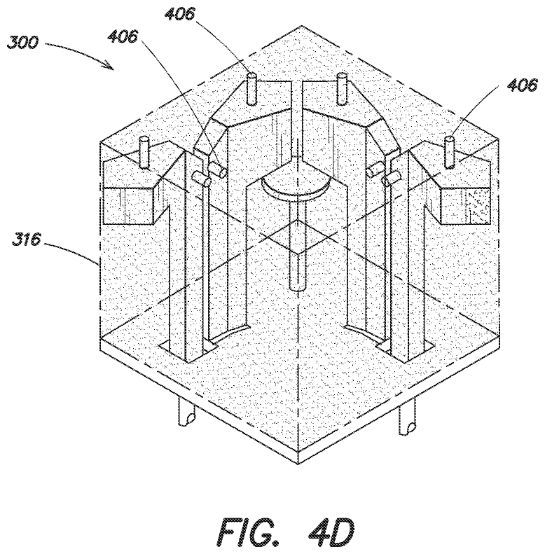

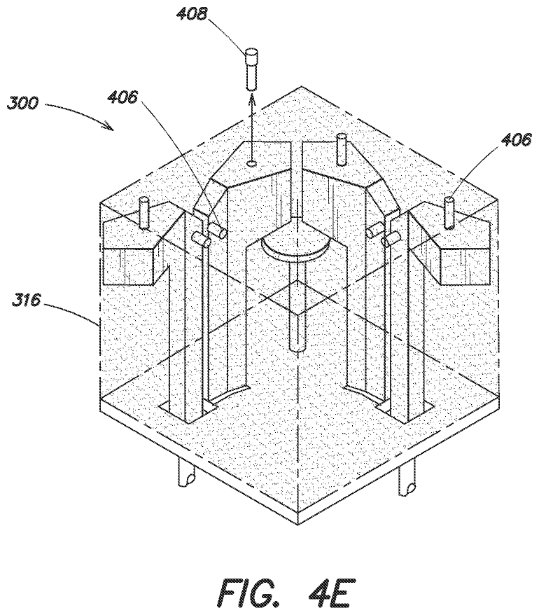

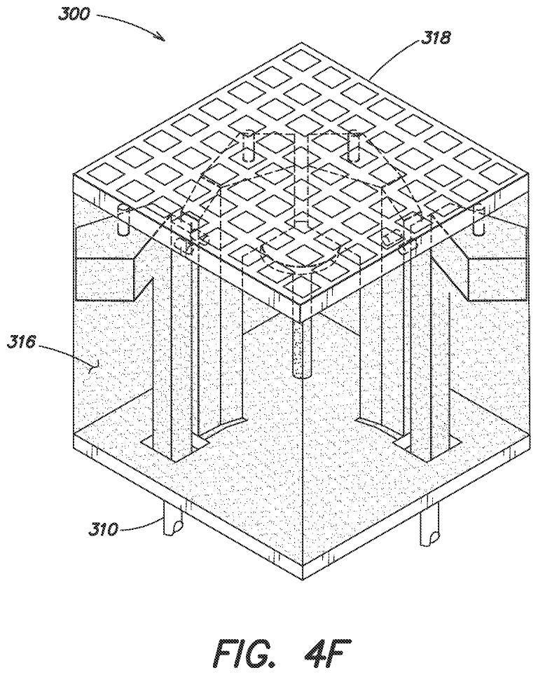

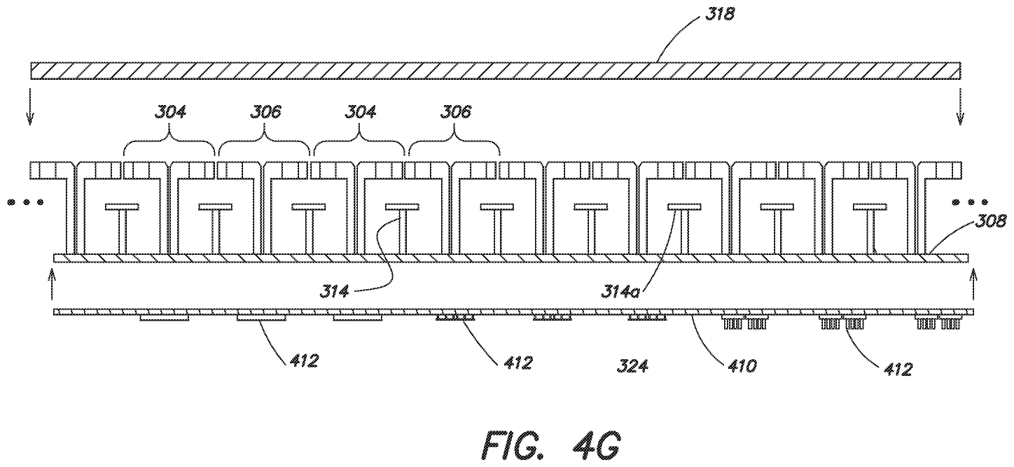

FIGS. 4A-F are top isometric perspective views of various structures during several stages of fabrication of the modular antenna 300 of FIGS. 3A-D, in accordance with an example of the present disclosure. In general, the modular antenna 300, including one or more unit cells 302 or portions thereof, is printed or otherwise fabricated using additive manufacturing techniques. It will be understood that any number of the unit cells 302 can be fabricated in the disclosed manner, for example, as component arrays (i.e., a single unit cell 302), blocks of sub-arrays (i.e., multiple adjacent unit cells 302), or complete arrays of the unit cells 302.

The modular antenna 300 and certain other structural or sacrificial components are fabricated by additively depositing or printing material to form the various structures of the antenna, such that the product is formed from a single piece of continuous material, also referred to as an integral element 320. The integral element 320 includes, for example, the first antenna element 304, the second antenna element 306, and the H-wall 314. In some examples, the material is at least partially electrically conductive (e.g., it is all metal or at least partially metal). In some other examples, the material is at least partially non-conductive and at least partially plated with another conductive material (e.g., a metal plating).

In some examples, the at least one non-conductive structural support element 316 includes a low dielectric foam or resin that is added to voids around the additively fabricated material of the antenna components. The foam or resin provides shock and vibration mitigation or other mechanical support of the antenna components, such as the first conductive dipole arm 304a, 306a, the second conductive dipole arm 304b, 306b, the first feedline 304c, 306c, and/or the second feedline 304d, 306d. In some examples, a perimeter caul plate 402 and a perforated top plate 404 can be placed around at least a portion of the modular antenna 300 to contain the at least one non-conductive structural support element 316 (e.g., foam or resin) during fabrication and prior to baking or setting the foam or resin into a semi-solid state.

In some examples, such as shown in FIGS. 4A-D, one or more mechanical alignment structures 406 are fabricated in conjunction with one or more antenna components, including, for example, the first conductive dipole arm 304a, 306a, the second conductive dipole arm 304b, 306b, the first feedline 304c, 306c, and the second feedline 304d, 306d. The alignment structures 406 align the top plate 404 with the first conductive dipole arm 304a, 306a, the second conductive dipole arm 304b, 306b. The at least one non-conductive structural support element 316 is added prior to removal of the alignment structures 406. Once set, at least a portion of the at least one non-conductive structural support element 316 (e.g., foam or resin) provides structural support for the first conductive dipole arm 304a, 306a, the second conductive dipole arm 304b, 306b. Other portions of the at least one non-conductive structural support element 316 and any mechanical alignment structures 406 not needed for structural support can then be machined or otherwise removed, such as shown at 408 in FIG. 4E. In some examples, a superstrate, such as the superstrate 318, or other overlay material can be attached to the modular antenna 300, such as shown in FIG. 4F.

FIG. 4G is a cross-sectional plan view of the modular antenna 300, in accordance with an example of the present disclosure. In some examples, a circuit board 410 can be attached at or to the ground plane 308, such as shown in FIG. 4G. The circuit board 410 can be configured to provide signal paths between the various components of the modular antenna array, such as the first feedline 304c, 306c, the second feedline 304d, 306d, and/or the H-wall 314 of each component antenna of the TCDA 100. The circuit board can include terminations or other connectors 412.

### Further Example Examples

The following examples pertain to further examples, from which numerous permutations and configurations will be apparent.

Example 1 provides an antenna assembly including a single-ended antenna feed configured to receive a single-ended signal; a ground plane; a conductive dipole arm in planar alignment with a surface of the ground plane; and a conductive wall (“H-wall”) electrically coupled with the ground plane and having an end adjacent to, and physically separate from, the conductive dipole arm, an axial length of the H-wall being orthogonal to the ground plane.

Example 2 includes the subject matter of Example 1, further including a feedline electrically coupled with the conductive dipole arm and the single-ended antenna feed.

Example 3 includes the subject matter of Example 2, further including at least one non-conductive structural support element between the ground plane and the feedline.

Example 4 includes the subject matter of Example 3, wherein the at least one non-conductive structural support includes a controlled dielectric foam or resin.

Example 5 includes the subject matter of any one of Examples 1-4, wherein the conductive dipole arm is a first conductive dipole arm and the feedline is a first feedline, and wherein the antenna assembly further includes a second conductive dipole arm in planar alignment with the surface of the ground plane and adjacent to the first conductive dipole arm; and a second feedline electrically coupled with the second conductive dipole arm and the ground plane.

Example 6 includes the subject matter of Example 5, further including a third conductive dipole arm in planar alignment with the surface of the ground plane and adjacent to the second conductive dipole arm; a fourth conductive dipole arm in planar alignment with the surface of the ground plane and adjacent to the third conductive dipole arm; a third feedline electrically coupled with the third conductive dipole arm and the single-ended antenna feed; and a fourth feedline electrically coupled with the fourth conductive dipole arm and the ground plane.

Example 7 includes the subject matter of Example 6, wherein the end of the H-wall is further adjacent to, and physically separate from, the third conductive dipole arm.

Example 8 includes the subject matter of Example 7, wherein the third conductive dipole arm is perpendicular to the second conductive dipole arm.

Example 9 includes the subject matter of any one of Examples 7 and 8, wherein the first conductive dipole arm is parallel to the second conductive dipole arm, and wherein the fourth conductive dipole arm is parallel to the third conductive dipole arm.

Example 10 includes the subject matter of any one of Examples 6-9, wherein the first and second conductive dipole arms are linearly polarized with respect to a first plane of polarization, wherein the third and fourth conductive dipole arms are linearly polarized with respect to a second plane of polarization, and wherein the first plane of polarization is orthogonal to the second plane of polarization.

Example 11 includes the subject matter of any one of Examples 1-10, further including an integral element additively manufactured into a single continuous piece of material, the integral element including the ground plane, the conductive dipole arm and the H-wall.

Example 12 includes the subject matter of Example 11, wherein the integral element includes an electrically conductive material.

Example 13 includes the subject matter of any one of Examples 11 and 12, wherein the integral element includes a non-conductive material plated with an electrically conductive material.

Example 14 provides an antenna assembly method including additively manufacturing an integral element as a single continuous piece of material, the integral element including a single-ended antenna feed configured to receive a single-ended signal; a ground plane; a conductive dipole arm in planar alignment with a surface of the ground plane; a feedline electrically coupled with the conductive dipole arm and the single-ended antenna feed; a conductive wall (“H-wall”) electrically coupled with the ground plane and having an end adjacent to, and physically separate from, the conductive dipole arm, an axial length of the H-wall being orthogonal to the ground plane; and attaching a superstrate to the integral element.

Example 15 includes the subject matter of Example 14, further including attaching at least one non-conductive structural support element between the ground plane and the feedline.

Example 16 includes the subject matter of Example 15, wherein the at least one non-conductive structural support includes a dielectric foam or resin.

Example 17 includes the subject matter of any one of Examples 14-16, wherein the integral element includes an electrically conductive material.

Example 18 includes the subject matter of any one of Examples 14-17, wherein the integral element includes a non-conductive material plated with an electrically conductive material.

Example 19 includes the subject matter of any one of Examples 14-18, wherein the conductive dipole arm is a first conductive dipole arm and the feedline is a first feedline, and wherein the integral element further includes a second conductive dipole arm in planar alignment with the surface of the ground plane and adjacent to the first conductive dipole arm; and a second feedline electrically coupled with the second conductive dipole arm and the ground plane.

Example 20 includes the subject matter of Example 19, wherein the integral element further includes a third conductive dipole arm in planar alignment with the surface of the ground plane and adjacent to the second conductive dipole arm; a fourth conductive dipole arm in planar alignment with the surface of the ground plane and adjacent to the third conductive dipole arm; a third feedline electrically coupled with the third conductive dipole arm and the single-ended antenna feed; and a fourth feedline electrically coupled with the fourth conductive dipole arm and the ground plane, wherein the end of the H-wall is further adjacent to, and physically separate from, the third conductive dipole arm.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. Furthermore, examples described herein may include other elements and components not specifically described, such as electrical connections, signal transmitters and receivers, processors, or other suitable components for operation of the modular antenna.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. An antenna assembly comprising:
a single-ended antenna feed configured to receive a single-ended signal;
a ground plane;
a conductive dipole arm in planar alignment with a surface of the ground plane; and
a conductive wall (“H-wall”) electrically coupled with the ground plane and having an end adjacent to, and physically separate from, the conductive dipole arm, an axial length of the H-wall being orthogonal to the ground plane.

2. The antenna assembly of claim 1, further comprising:
a feedline electrically coupled with the conductive dipole arm and the single-ended antenna feed.

3. The antenna assembly of claim 2, further comprising at least one non-conductive structural support element between the ground plane and the feedline.

4. The antenna assembly of claim 3, wherein the at least one non-conductive structural support includes a controlled dielectric foam or resin.

5. The antenna assembly of claim 2, wherein the conductive dipole arm is a first conductive dipole arm and the feedline is a first feedline, and wherein the antenna assembly further comprises:
a second conductive dipole arm in planar alignment with the surface of the ground plane and adjacent to the first conductive dipole arm; and
a second feedline electrically coupled with the second conductive dipole arm and the ground plane.

6. The antenna assembly of claim 5, further comprising:
a third conductive dipole arm in planar alignment with the surface of the ground plane and adjacent to the second conductive dipole arm;
a fourth conductive dipole arm in planar alignment with the surface of the ground plane and adjacent to the third conductive dipole arm;
a third feedline electrically coupled with the third conductive dipole arm and the single-ended antenna feed; and
a fourth feedline electrically coupled with the fourth conductive dipole arm and the ground plane.

7. The antenna assembly of claim 6, wherein the end of the H-wall is further adjacent to, and physically separate from, the third conductive dipole arm.

8. The antenna assembly of claim 7, wherein the third conductive dipole arm is perpendicular to the second conductive dipole arm.

9. The antenna assembly of claim 7, wherein the first conductive dipole arm is parallel to the second conductive dipole arm, and wherein the fourth conductive dipole arm is parallel to the third conductive dipole arm.

10. The antenna assembly of claim 6, wherein the first and second conductive dipole arms are linearly polarized with respect to a first plane of polarization, wherein the third and fourth conductive dipole arms are linearly polarized with respect to a second plane of polarization, and wherein the first plane of polarization is orthogonal to the second plane of polarization.

11. The antenna assembly of claim 1, further comprising an integral element additively manufactured into a single continuous piece of material, the integral element including the ground plane, the conductive dipole arm and the H-wall.

12. The antenna assembly of claim 11, wherein the integral element includes an electrically conductive material.

13. The antenna assembly of claim 11, wherein the integral element includes a non-conductive material plated with an electrically conductive material.

14. An antenna assembly method comprising:
additively manufacturing an integral element as a single continuous piece of material, the integral element comprising:
a single-ended antenna feed configured to receive a single-ended signal;
a ground plane;
a conductive dipole arm in planar alignment with a surface of the ground plane;
a feedline electrically coupled with the conductive dipole arm and the single-ended antenna feed;
a conductive wall (“H-wall”) electrically coupled with the ground plane and having an end adjacent to, and physically separate from, the conductive dipole arm, an axial length of the H-wall being orthogonal to the ground plane; and
attaching a superstrate to the integral element.

15. The antenna assembly method of claim 14, further comprising attaching at least one non-conductive structural support element between the ground plane and the feedline.

16. The antenna assembly method of claim 15, wherein the at least one non-conductive structural support includes a dielectric foam or resin.

17. The antenna assembly method of claim 14, wherein the integral element includes an electrically conductive material.

18. The antenna assembly method of claim 14, wherein the integral element includes a non-conductive material plated with an electrically conductive material.

19. The antenna assembly method of claim 14, wherein the conductive dipole arm is a first conductive dipole arm and the feedline is a first feedline, and wherein the integral element further comprises:
a second conductive dipole arm in planar alignment with the surface of the ground plane and adjacent to the first conductive dipole arm; and
a second feedline electrically coupled with the second conductive dipole arm and the ground plane.

20. The antenna assembly method of claim 19, wherein the integral element further comprises:
a third conductive dipole arm in planar alignment with the surface of the ground plane and adjacent to the second conductive dipole arm;
a fourth conductive dipole arm in planar alignment with the surface of the ground plane and adjacent to the third conductive dipole arm;
a third feedline electrically coupled with the third conductive dipole arm and the single-ended antenna feed; and
a fourth feedline electrically coupled with the fourth conductive dipole arm and the ground plane,
wherein the end of the H-wall is further adjacent to, and physically separate from, the third conductive dipole arm.
